(19) United States
(12) Patent Application Publication
(10) Pub. No.: US 2018/0326667 A1
(43) Pub. Date: Nov. 15, 2018

(54) BUILDING APPARATUS, BUILDING METHOD, AND BUILDING SYSTEM

(71) Applicant: MIMAKI ENGINEERING CO., LTD., Nagano (JP)

(72) Inventor: Kenji Harayama, Nagano (JP)

(73) Assignee: MIMAKI ENGINEERING CO., LTD., Nagano (JP)

(21) Appl. No.: 15/975,774

(22) Filed: May 10, 2018

(30) Foreign Application Priority Data
May 11, 2017 (JP) 2017-094931

(51) Int. Cl. B29C 64/393; B33Y 10/00; B33Y 30/00; B33Y 50/02; B29C 64/112; B29C 64/209

(52) U.S. Cl. CPC B29C 64/393; B33Y 10/00; B29C 64/209; B33Y 50/02; B29C 64/112; B33Y 30/00

(57) ABSTRACT

Provided is a building apparatus configured to build a product, including: an ejection head having nozzles; a scan driver configured to control the ejection head to perform a main scanning operation; and a controller. When all the nozzles in the ejection head are normal nozzles, the controller controls the ejection head to perform the main scanning operation by setting the line density of a line formed by each of the nozzles to be a normal-condition density set in advance. When a defective nozzle in which an ejection amount is smaller than a standard range is present in the nozzles in the ejection head, the controller controls the ejection head to perform the main scanning operation by setting the line density of the line formed by any of the nozzles other than the defective nozzle to be higher than the normal-condition density in at least some of the main scanning operations.

### CROSS REFERENCE TO RELATED APPLICATIONS

This application claims the priority benefit of Japanese Patent Application No. 2017-094931, filed on May 11, 2017. The entirety of the above-mentioned patent application is hereby incorporated by reference herein and made a part of this specification.

### TECHNICAL FIELD

The disclosure relates to a building apparatus, a building method, and a building system.

### BACKGROUND ART

Building apparatuses (3D printers) that build products using inkjet heads have been known (for example, see Japanese Unexamined Patent Application Publication No. 2015-71282). In such a building apparatus, for example, a product is built by additive manufacturing by adding a plurality of layers of building materials ejected from an ejection head such as an inkjet head.

Patent Literature: Japanese Unexamined Patent Application Publication No. 2015-71282.

### SUMMARY

When a product is built by additive manufacturing using an ejection head such as an inkjet head, in general, building materials are ejected from a large number of nozzles formed in a single ejection head to form layers of the building materials. When such a configuration is used, however, defective nozzles whose ejection characteristics are out of the normal range may occur due to clogging of nozzles, for example. When the defective nozzles occur, it may be difficult to build an object with high accuracy if the object is built in this state.

The problem of occurrence of defective nozzles similarly arises in, for example, an inkjet printer for printing two-dimensional images. The occurrence of defective nozzles in the inkjet printer makes it difficult to print high-definition images. Thus, when defective nozzles have occurred in the inkjet printer, for example, it is a common practice to perform nozzle alternate processing by using operation of a multi-pass method.

For example, also in the case where an object is built by a building apparatus, the nozzle alternate processing may be performed similarly to printing with an inkjet printer. In the case of the building apparatus, however, matters required for forming layers of building materials are not always the same as those for printing by an inkjet printer. In the case where the nozzle alternate processing is performed by using the operation of the multi-pass method, it may be difficult to build objects efficiently because the manner of setting of passes in the multi-pass method is restricted. Thus, in the building apparatus, it is desired to reduce the influence of defective nozzles by a method more suited to the building operation. The disclosure is then aimed to provide a building apparatus, a building method, and a building system capable of solving the above-mentioned problems.

The inventors of the present application conducted diligent research on the influence of defective nozzles occurring in an ejection head in a building apparatus. In regard to this issue involving the influence of defective nozzles causing a problem particularly in building, the inventors of the present application focused on the fact that streaks are generated due to insufficient amount of building material. More specifically, when abnormality of small ejection amount (for example, abnormality of non-ejection) occurs in some nozzles in an ejection head, if the nozzles are used to build an object, building material is insufficient at positions where building material should be ejected from the nozzles. As a result, for example, when the ejection head is controlled to perform a main scanning operation to form a layer of building material, groove-like streaks generated by insufficient amount of building material are formed on the layer of building material so as to extend in the main scanning direction.

The influence of such streaks can be considered small as long as only one layer is formed, for example. In the building by additive manufacturing, however, for example, a large number of layers are formed while being stacked on one another. If the amount of building material is insufficient in each layer, the accuracy of building may be affected.

In regard to this issue, for example, the influence of defective nozzles can be appropriately suppressed by the nozzle alternate processing in the same manner as printing with an inkjet printer. As described above, however, in this case, it may be difficult to build objects efficiently because the manner of setting of passes in a multi-pass method is restricted. In printing with an inkjet printer, in general, the entire layer of formed ink constitutes a printed image. Thus, in a method for suppressing the influence of defective nozzles, the influence on the appearance in a printing result needs to be sufficiently reduced. Because of such need, a method in which alternate processing is performed on defective nozzles has been employed.

In the building by additive manufacturing, on the other hand, many parts of deposited building material serve as a region inside the product. In this case, in a method for suppressing the influence of defective nozzles, importance can be placed on other influences than the influence on the appearance unlike an inkjet printer.

Thus, the inventors of the present application thought of, as a method for suppressing the influence of defective nozzles, a method in which when there is a defective nozzle having a small ejection amount, the ejection amounts of nozzles other than the defective nozzle are increased instead of the alternate processing. The inventors of the present application found that the use of such a method can appropriately suppress the influence of defective nozzles. The inventor has conducted even more elaborate studies and has found features necessary for obtaining such effects. This finding has led to completion of the disclosure.

To solve the above-mentioned problems, the disclosure provides a building apparatus configured to build a three-dimensional product by additive manufacturing, including: an ejection head having a plurality of nozzles each configured to eject building material as material used for building; a scan driver configured to control the ejection head to perform a main scanning operation in which the building material is ejected from the nozzles while the ejection head moves in a main scanning direction set in advance relatively to the object being built; and a controller configured to control operations of the ejection head and the scan driver, in which the ejection head includes the nozzles arranged at positions shifted from one another in a sub scanning direction orthogonal to the main scanning direction, in a case where arrangement of dots formed by the building material ejected from one of the nozzles in the single main scanning operation is defined as a line, an amount of the building material included in a unit length in one line is defined as a line density, a nozzle in which an ejection amount that is an amount of the building material ejected from one nozzle in one ejection operation falls within a standard range set in advance is defined as a normal nozzle, and a nozzle other than the normal nozzle is defined as a defective nozzle, when all the nozzles in the ejection head are the normal nozzles, the controller controls the ejection head to perform the main scanning operation by setting the line density of the line formed by each of the nozzles to be a normal-condition density set in advance, and when the defective nozzle in which the ejection amount is smaller than the standard range is present in the nozzles in the ejection head, the controller controls the ejection head to perform the main scanning operation by setting the line density of the line formed by any of the nozzles other than the defective nozzle to be higher than the normal-condition density in at least some of the main scanning operations.

With such a configuration, for example, when any of the nozzles in the ejection head becomes a non-ejection nozzle to have a small ejection amount, the insufficient ejection amount can be appropriately compensated by the building material ejected from the other nozzles. Consequently, for example, streaks due to insufficient amount of building material can be appropriately prevented from being generated in a layer of the building material. Thus, for example, such a configuration can appropriately suppress the influence of defective nozzles when an object is built by additive manufacturing using an ejection head having nozzles. Consequently, for example, a product can be appropriately built with high accuracy.

Setting the line density to be higher than the normal-condition density means, for example, setting the ejection amount of building material ejected from a nozzle to be larger than the normal case at some timings at least in the operation for forming the line. In this configuration, it is preferred that the building apparatus further include a planarizing roller configured to planarize a layer of the building material. For example, such a configuration can appropriately remove surplus building material when the ejection amount of the normal nozzle is increased. Consequently, the layer of the building material can be more appropriately formed with high accuracy.

When a defective nozzle having a small ejection amount is present, for example, the line density of a nozzle adjacent to the defective nozzle may be set to be higher than the normal-condition density. In this case, for example, the line density of a nozzle located at a position that sandwiches one nozzle with the defective nozzle in the sub scanning direction may be set to be higher than the normal-condition density.

In the case where layers to be deposited by additive manufacturing are formed by operation of a multi-pass method, a nozzle for increasing the line density may be selected in consideration of the operation of the multi-pass method. More specifically, when a layer is formed by the multi-pass method, the interval of the nozzles in the ejection head in the sub scanning direction may be an integer multiple of a building resolution in the sub scanning direction. In this case, lines adjacent in the sub scanning direction in one layer are formed by the main scanning operation at a different time. Thus, in this case, the line density of a nozzle that actually forms a line adjacent to a line corresponding to the defective nozzle instead of a nozzle that is actually adjacent to the defective nozzle in the ejection head may be set to be higher than the normal-condition density.

As a nozzle to be set to increase the line density, a plurality of nozzles may be selected for each defective nozzle. In this case, for example, a plurality of nozzles may be selected for each of nozzles on one and the other sides of the defective nozzle in the sub scanning direction. As the line density, for example, an average line density of nozzles including a defective nozzle may be adjusted to fall within a predetermined range. In this case, a group of nozzles arranged with the defective nozzle as the center in the sub scanning direction may be selected as the nozzles including the defective nozzle. In this case, line densities of nozzles other than the defective nozzle in the group may be increased. For another example, line densities of some nozzles in the group may be set to be lower than the normal-condition density.

A group of nozzles used to calculate the average line density may be set in consideration of the operation of the multi-pass method. In this case, for example, a group including nozzles configured to form lines arranged sequentially in the sub scanning direction in one layer is set, and an average line density in the group is set to fall within a predetermined range.

As the setting for increasing the line density, the setting such that building material is ejected with an ejection amount larger than a normal-condition maximum ejection amount that is a maximum ejection amount in normal operation may be used. Examples of the setting include the setting for forming a large-sized dot (large droplet for compensation) used to compensate for ejection characteristics of the defective nozzle.

More specifically, in the case where an ejection head (binary head) capable of setting only one kind of ejection amount at normal ejection timing is used as the ejection head, the ejection amount larger than the normal-condition maximum ejection amount means an ejection amount larger than the one kind of ejection amount. In the case where an ejection head (multi-value head) capable of selecting a plurality of quantities of the ejection amount (for example, large, medium, and small ejection amounts) is used as the ejection head, the ejection amount larger than the normal-condition maximum ejection amount means an ejection amount larger than the maximum ejection amount among the plurality of quantities of the ejection amount.

In this configuration, as the product, for example, an object including a single-material region that is a region formed of only one kind of building material may be built. In this case, for example, the ejection head in this configuration may be an ejection head used to form the single-material region. As the product, for another example, an object in which at least a part is colored with building material for coloring may be built. In this case, the ejection head in this configuration may be an ejection head configured to eject the building material for coloring.

In the main scanning operation, the controller controls each of the nozzles in the ejection head to eject the building material based on ejection position designation data that is data for designating a position at which the building material is ejected from each of the nozzles in the ejection head. For example, the controller receives the ejection position designation data from a data generation apparatus outside the building apparatus. In this case, for example, the data generation apparatus is an apparatus configured to perform RIP processing.

When a defective nozzle having a small ejection amount is present, for example, the data generation apparatus generates defective nozzle presence data that is ejection position designation data for controlling the defective nozzle not to eject the building material and setting the line density of a line formed by any nozzle other than the defective nozzle to be higher than the normal-condition density. For example, the controller in the building apparatus controls each of the nozzles to eject the building material based on the defective nozzle presence data, thereby setting the line density for each of the nozzles.

In this case, it is preferred that before the building apparatus starts building operation, the controller check whether the defective nozzle presence data used for building is correct data. More specifically, in this case, for example, the controller communicates with the data generation apparatus, and inquires information on the defective nozzle to check whether the defective nozzle present in the ejection head and the defective nozzle taken into consideration for generating the ejection position designation data are the same. In this case, for example, the building apparatus may be controlled to start the building operation only when it is confirmed that the defective nozzles are the same. When it cannot be confirmed that the defective nozzles are the same, the data generation apparatus may generate new ejection position designation data. For example, such a configuration can appropriately prevent an object to be built by using incorrect ejection position designation data.

As the ejection position designation data, for example, data generated by subjecting a portion corresponding to at least part of the product to halftone processing by using error diffusion or dithering may be used. In this case, in the halftone processing, it is preferred to use error diffusion or dithering while excluding a position at which the building material is ejected from the defective nozzle. For example, such a configuration can appropriately generate the ejection position designation data in accordance with the state in which the defective nozzle is present.

As the configuration of the disclosure, a building method and a building system having the same features as described above may be used. Also in this case, for example, the same effects as described above can be obtained. In this case, for example, the building method may be a method of manufacturing a product.

According to the disclosure, for example, in the case of building an object by additive manufacturing using an ejection head having nozzles, influence of defective nozzles can be appropriately suppressed.

### BRIEF DESCRIPTION OF THE DRAWINGS

FIGS. 1A to 1C are diagrams illustrating an example of a building system 10 according to one embodiment of the disclosure, in which FIG. 1A illustrates an example of a configuration of the building system 10, FIG. 1B illustrates an example of a configuration of a main part of a building apparatus 12, and FIG. 1C illustrates an example of a configuration of a head 102;

FIGS. 2A and 2B are diagrams for describing a product 50 to be built by a building apparatus 12 (see FIGS. 1A to 1C) in the present example in more detail, in which FIG. 2A illustrates an example of a configuration of the product 50 to be built by the building apparatus 12, and FIG. 2B schematically illustrates how building materials are ejected from inkjet heads during main scanning operation;

FIGS. 3A to 3C are diagrams for describing influence of defective nozzles in more detail, in which FIG. 3A illustrates an example of arrangement of dots of ink formed by the main scanning operation when all nozzles in the inkjet heads are normal nozzles, FIG. 3B illustrates an example of arrangement of dots of ink formed by the main scanning operation when some nozzles in the inkjet heads are defective nozzles, and FIG. 3C is a diagram schematically illustrating the influence of the defective nozzles;

FIGS. 4A to 4D are diagrams for describing a method of suppressing the influence of the defective nozzles in the present example in more detail, in which FIG. 4A schematically illustrates lines 304 formed without defective nozzles, FIG. 4B schematically illustrates lines 304 formed in the state in which non-ejection defective nozzles occur, FIG. 4C schematically illustrates the state in which peripheral lines 304 are formed so as to suppress the influence of defective nozzles, and FIG. 4D illustrates an example of the sizes of dots formed in the case where a multi-value head is used;

FIG. 5 is a flowchart illustrating an example of operation of the building system 10 in the present example;

FIG. 6 illustrates an example of halftone processing using error diffusion;

FIG. 7 illustrates an example of halftone processing using dithering;

FIGS. 8A and 8B are diagrams for describing a threshold matrix deformation processing in more detail, in which FIG. 8A illustrates an example of a threshold matrix (dither matrix) before deformation, and FIG. 8B illustrates an example of threshold matrix deformation processing performed in consideration of defective nozzles;

FIGS. 9A and 9B are diagrams for describing diffusion matrix deformation processing in more detail, in which FIG. 9A illustrates an example of diffusion matrix processing before deformation, and FIG. 9B illustrates an example of diffusion matrix deformation processing performed in consideration of defective nozzles;

FIGS. 10A to 10C are diagrams for describing communication performed between the building apparatus 12 and the control PC 14 in more detail, in which FIGS. 10A to 10C illustrate an example of communication performed between the building apparatus 12 and the control PC 14 in the case where products are built at various timings.

### DESCRIPTION OF EMBODIMENTS

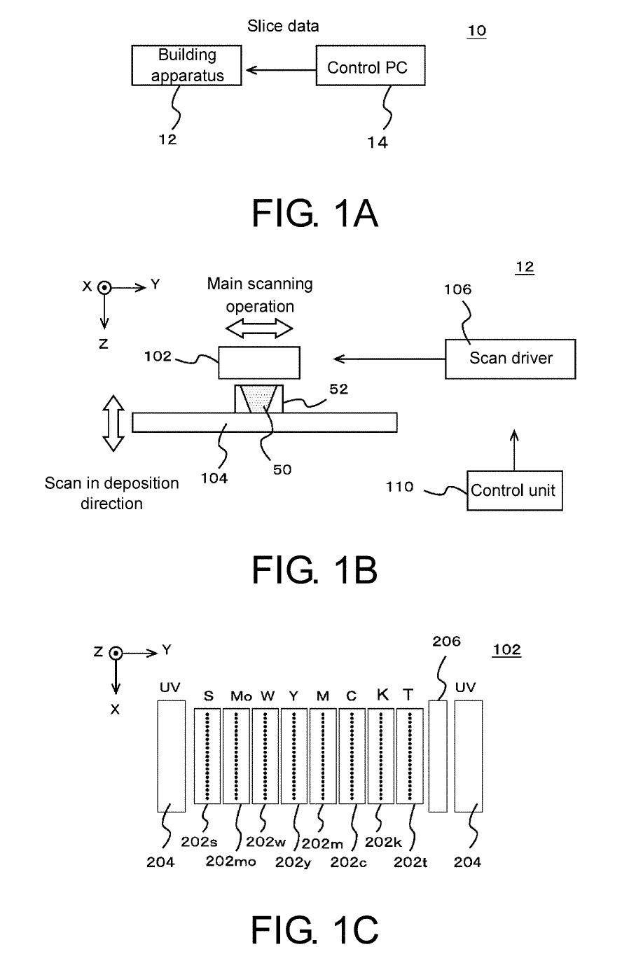

Embodiments according to the disclosure will be described below with reference to the figures. FIGS. 1A to 1C illustrate an example of a building system 10 according to one embodiment of the disclosure. FIG. 1A illustrates an example of a configuration of the building system 10. In the present example, the building system 10 is a building system configured to build a three-dimensional product, and includes a building apparatus 12 and a control PC 14.

The building apparatus 12 is an apparatus configured to execute building of a product, and builds an object in accordance with control by the control PC 14. Further, more specifically, the building apparatus 12 is a full-color building apparatus capable of building a full-colored object. The building apparatus 12 receives data indicating a product to be built from the control PC 14, and builds the object based on the data. Further, in the present example, the building apparatus 12 receives slice data indicating a cross-section of a product as data indicating the object, and builds the object based on the slice data.

The control PC 14 is a computer (host PC) configured to control the operation of the building apparatus 12. In the present example, the control PC 14 generates slice data indicating a product to be built by the building apparatus 12, and supplies the slice data to the building apparatus 12. Further, in response thereto, the control PC 14 controls the operation of the building by the building apparatus 12.

Note that, in the present example, the slice data is data indicating cross-sections of layers to be deposited by additive manufacturing. More specifically, for example, the slice data is data for designating positions where building materials are ejected during the formation of layers constituting a product. In this case, to designate the positions where the building materials are ejected means, for example, to designate positions (ejection positions) where building materials are ejected from nozzles in an inkjet head configured to eject building materials in a building apparatus. In the present example, the slice data is an example of ejection position designation data. The control PC 14 is an example of a data generation apparatus configured to generate the ejection position designation data.

As described above, in the present example, the building system 10 is constituted by the building apparatus 12 and the control PC 14 that are a plurality of apparatuses. However, in a modification of the building system 10, the building system 10 may be configured by a single apparatus. In this case, for example, the building system 10 may be configured by a single building apparatus 12 including the functions of the control PC 14.

Subsequently, a specific configuration of the building apparatus 12 is described. FIG. 1B illustrates an example of a configuration of a main part of the building apparatus 12. In the present example, the building apparatus 12 is a building apparatus configured to build a three-dimensional product 50, and includes a head 102, a stage 104, a scan driver 106, and a controller 110.

The building apparatus 12 may have the same or similar configuration as well-known building apparatuses, except for the points described below. More specifically, for example, the building apparatus 12 may have the same or similar configuration as a well-known building apparatus that builds a product by ejecting droplets as the material of a product 50 using inkjet heads, except for the points described below. The building apparatus 12 may further include, for example, a variety of components necessary for building or coloring a product 50, in addition to the components illustrated in the figure. In the present example, the building apparatus 12 is a building apparatus (3D printer) that builds a three-dimensional product 50 by additive manufacturing. In this case, additive manufacturing refers to, for example, a process of building a product 50 by adding layers one after another. The product 50 refers to, for example, a three-dimensional structure.

The head 102 is a part configured to eject building material used to build a product 50. In the present example, ink is used as the building material. In this case, ink refers to, for example, liquid ejected from the inkjet head. More specifically, the head 102 ejects, from a plurality of inkjet heads, ink that hardens depending on a predetermined condition as the building material. By curing the landed ink, layers constituting the product 50 are stacked and formed to build the object by additive manufacturing. In the present example, UV curable ink (UV ink) that is cured from the liquid state through irradiation of ultraviolet rays is used as ink.

The head 102 further ejects ink as material for the support layer 52 in addition to the ink used to form layers of the product 50. The head 102 thus forms the support layer 52, as necessary, on the periphery of the product 50. The support layer 52 refers to, for example, a deposited structure that surrounds the outer periphery of a product 50 being built to support the product 50. The support layer 52 is formed as necessary during building of a product 50 and removed after the building is finished.

The stage 104 is a table-shaped member for supporting a product 50 being built and is disposed at a position opposed to the inkjet heads in the head 102. The product 50 being built is placed on the upper surface of the stage 104. In the present example, the stage 104 is configured such that at least its upper surface is movable in the deposition direction (the Z direction in the figure). The stage 104 is driven by the scan driver 106 so that at least its upper surface is moved as the building of a product 50 proceeds. In this case, the deposition direction refers to, for example, a direction in which the building material is deposited in additive manufacturing. More specifically, in the present example, the deposition direction is a direction orthogonal to the main scanning direction (the Y direction in the figure) and the sub scanning direction (the X direction in the figure).

The scan driver 106 is a driver that causes the head 102 to perform a scanning operation of moving relative to the product 50 being built. In this case, moving relative to the product 50 being built means, for example, moving relative to the stage 104. Causing the head 102 to perform a scanning operation means, for example, causing the inkjet heads of the head 102 to perform a scanning operation. In the present example, the scan driver 106 causes the head 102 to perform a main scanning operation (Y scan), a sub scanning operation (X scan), and a deposition-direction scanning (Z scan).

The main scanning operation is, for example, the operation of ejecting ink while moving in the main scanning direction relative to the product 50 being built. In the present example, the scan driver 106 causes the head 102 to perform a main scanning operation by moving the head 102 while fixing the position of the stage 104 in the main scanning direction. The scan driver 106 may move the product 50, for example, by moving the stage 104, for example, while fixing the position of the head 102 in the main scanning direction.

The sub scanning operation is, for example, the operation of moving relative to the product 50 being built in the sub scanning direction orthogonal to the main scanning direction. More specifically, the sub scanning operation is, for example, the operation of moving relative to the stage 104 in the sub scanning direction by a preset feed amount. In the present example, the scan driver 106 causes the head 102 to perform the sub scanning operation by moving the stage 104 while fixing the position of the head 102 in the sub scanning direction, in the interval between the main scanning operations. Alternatively, the scan driver 106 may cause the head 102 to perform the sub scanning operation by moving the head 102 while fixing the position of the stage 104 in the sub scanning direction.

Deposition direction scanning means, for example, the operation of moving at least one of the head 102 and the stage 104 in the deposition direction such that the head 102 is moved in the deposition direction with respect to the product 50 being built. The scan driver 106 controls the head 102 to perform the deposition direction scanning in accordance with the progress of the building operation, thereby adjusting the relative position of the inkjet head with respect to the product 50 being built in the deposition direction. More specifically, in the present example, the scan driver 106 moves the stage 104 while fixing the position of the head 102 in the deposition direction. The scan driver 106 may move the head 102 while fixing the position of the stage 104 in the deposition direction.

The controller 110 is, for example, a CPU in the building apparatus 12, and controls each unit in the building apparatus 12 to control the operation of building a product 50. In the present example, the controller 110 controls each unit in the building apparatus 12 based on slice data received from the control PC 14. In this case, for example, the controller 110 controls the operation of each inkjet head in the head 102 to control each inkjet head to eject ink used to build the product. In the present example, the product 50 can be appropriately built.

Subsequently, the configuration of the head 102 in the building apparatus 12 is described in more detail. FIG. 1C illustrates an example of the configuration of the head 102. In the present example, the head 102 has a plurality of inkjet heads, a plurality of UV light sources 204, and a planarizing roller 206. As illustrated in FIG. 1C, the inkjet heads include an inkjet head 202s, an inkjet head 202mo, an inkjet head 202w, an inkjet head 202y, an inkjet head 202m, an inkjet head 202c, an inkjet head 202k, and an inkjet head 202t. The inkjet heads are an example of an ejection head. For example, the inkjet heads are arranged side by side in the main scanning direction such that the positions in the sub scanning direction are aligned with one another. Each of the inkjet heads has a nozzle row in which nozzles each configured to eject ink are arranged in a predetermined nozzle row direction. In the present example, the nozzle row direction is a direction parallel to the sub scanning direction. Thus, the nozzles in each of the inkjet heads are arranged in the nozzle row such that the positions in the sub scanning direction are shifted from one another.

Of these inkjet heads, the inkjet head 202s is an inkjet head ejecting the material of the support layer 52. For example, well-known materials for support layers can be suitably used as the material of the support layer 52. The inkjet head 202mo is an inkjet head ejecting a building material ink (Mo ink). In this case, the building material ink is, for example, ink dedicated for building and used for building the interior (interior region) of the product 50.

The interior of the product 50 may be formed using ink of another color, in addition to the building material ink. For example, the interior of the product 50 may be formed only with ink of another color (for example, white ink), without using the building material ink. In this case, the inkjet head 202mo in the head 102 may be omitted. For another example, the interior of the product 50 may be formed by using, without being limited to these kinds of ink, desired ink other than the material of the support layer 52.

The inkjet head 202w is an inkjet head ejecting white (w) ink. In the present example, white ink is an example of light-reflective ink and is used for, for example, forming a region (light-reflective region) having the property of reflecting light in the product 50.

The inkjet head 202y, the inkjet head 202m, the inkjet head 202c, and the inkjet head 202k (hereinafter referred to as inkjet heads 202y to 202k) are inkjet heads for coloring to be used for building a colored product 50 and eject coloring ink of colors different from each other. More specifically, the inkjet head 202y ejects yellow (Y) ink. The inkjet head 202m ejects magenta (M) ink. The inkjet head 202c ejects cyan (C) ink. The inkjet head 202k ejects black (K) ink. In this case, the colors Y, M, C, and K are examples of process colors used for full-color representation by subtractive color mixing. The inkjet head 202t is an inkjet head ejecting clear ink. The clear ink refers to, for example, ink of a colorless transparent (T) clear ink.

The UV light sources 204 are light sources (UV light sources) for curing ink and generate ultraviolet rays for curing UV-curable ink. In the present example, the UV light sources 204 are disposed on one end side and the other end side in the main scanning direction in the head 102 such that the row of inkjet heads is sandwiched therebetween. For example, ultraviolet LEDs (UVLEDs) can be suitably used as the UV light sources 204. Alternatively, for example, metal halide lamps or mercury vapor lamps may be used as the UV light sources 204.

The planarizing roller 206 is planarizing means for planarizing the layer of ink formed during building of a product 50. The planarizing roller 206 comes into contact with the surface of a layer of ink, for example, during the main scanning operation and partially removes the ink before curing to planarize the layer of ink.

The head 102 having a configuration as described above can be used to appropriately form layers of ink that constitute the product 50. The product 50 can be appropriately built by adding a plurality of layers of ink.

The specific configuration of the head 102 is not limited to the configuration described above and may be modified in various ways. For example, the head 102 may further include an inkjet head for a color other than those described above, as an inkjet head for coloring. The arrangement of the inkjet heads in the head 102 may also be modified in various ways. For example, some of the inkjet heads may be displaced from other inkjet heads in the sub scanning direction.

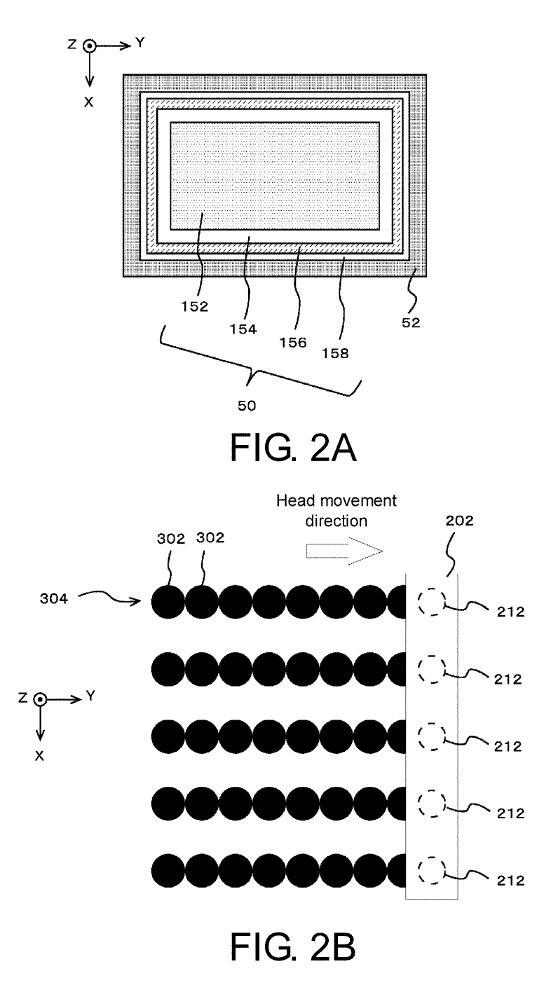

The product 50 to be built using the building apparatus 12 in the present example will be described in more detail. FIGS. 2A and 2B are diagrams for describing the product 50 built by the building apparatus 12 (see FIGS. 1A to 1C) in the present example in more detail. FIG. 2A is a diagram illustrating the configuration of the product 50 built by the building apparatus 12, and illustrates an example of the configuration in an X-Y cross section, which is a cross section of the product 50 orthogonal to the deposition direction (Z direction), together with the support layer 52. In this case, the configurations in a Z-X cross section and a Z-Y cross section of the product 50 perpendicular to the Y direction and the Z direction are the same configuration as the configuration in the X-Y cross section.

As described above, in the present example, for example, the building apparatus 12 builds a colored product 50 by using the inkjet heads 202y to 202k (see FIGS. 1A to 1C). In this case, the building apparatus 12 builds, as the product 50, a product 50 in which at least the surface thereof is colored. The state in which the surface of the product 50 is colored means, for example, the state in which at least a part of a region of the product 50 where hue can be visually recognized from the outside is colored. In this case, as illustrated in FIGS. 2A and 2B, for example, the building apparatus 12 builds a product 50 having an interior region 152, a light-reflective region 154, a colored region 156, and a protective region 158. As necessary, the building apparatus 12 forms the support layer 52 around the product 50.

The interior region 152 is a region that forms the interior of the product 50. The interior region 152 may be considered as a region that forms the shape of the product 50. In the present example, the building apparatus 12 forms the interior region 152 using building material ink ejected from the inkjet head 202mo (see FIGS. 1A to 1C). The light-reflective region 154 is a light-reflective region for reflecting light incident from the outside of the product 50 through the colored region 156, for example. In the present example, the building apparatus 12 forms the light-reflective region 154 around the interior region 152 using white ink ejected from the inkjet head 202w (see FIGS. 1A to 1C).

The colored region 156 is a region colored with coloring ink ejected from the inkjet heads 202y to 202k. In the present example, the building apparatus 12 forms the colored region 156 around the light-reflective region 154 by using the coloring ink ejected from the inkjet heads 202y to 202k and the clear ink ejected from the inkjet head 202t (see FIGS. 1A to 1C). In this manner, in the product 50, the colored region 156 is formed on the outer side of the light-reflective region 154. In this case, for example, various colors are represented by adjusting the amount of coloring ink of colors ejected to each position. Clear ink is used for compensating for variations in the amount of coloring ink (the amount of ejection per unit volume is 0% to 100%) due to the difference of color so that constant 100% is achieved. With such a configuration, for example, each position in the colored region 156 can be appropriately colored in a desired color.

The protective region 158 is a transparent region for protecting the outer surface of the product 50. In the present example, the building apparatus 12 uses the clear ink ejected from the inkjet head 202t to form the protective region 158 around the colored region 156. In this manner, the head 102 uses the transparent material to form the protective region 158 so as to cover the outer side of the colored region 156. Forming the respective regions as described above enables the product 50 having the colored surface to be appropriately formed.

In a modification of the product 50, a specific configuration of the product 50 may be different from the one described above. More specifically, for example, the interior region 152 and the light-reflective region 154 are not be distinguished from each other, and the interior region 152 also functioning as the light-reflective region 154 may be formed, for example, using white ink. Alternatively, part of the regions may be eliminated from the product 50. In this case, for example, the protective region 158 may be omitted. An additional region other than those described above may be formed in the product 50. In this case, for example, an isolation region may be formed between the light-reflective region 154 and the colored region 156. The isolation region refers to, for example, a transparent region (transparent layer) for preventing mixing of white ink forming the light-reflective region 154 and ink forming the colored region 156. In this case, for example, the building apparatus 12 uses the clear ink ejected from the inkjet head 202t to form the separation region around the light-reflective region 154.

As described above, in the present example, the building apparatus 12 ejects ink from each inkjet head in the head 102 (see FIGS. 1A to 1C) by the main scanning operation, thereby forming each part in the product 50. More specifically, in this case, ink is ejected from nozzles in the inkjet heads to form an ink layer. FIG. 2B is a diagram schematically illustrating how ink is ejected from the inkjet head in the main scanning operation.

In FIG. 2B, one inkjet head in the head 102 is illustrated as an inkjet head 202 for the sake of illustration. Only five nozzles 212 arranged sequentially in the sub scanning direction are illustrated as nozzles 212 arranged in a nozzle row in the inkjet head 202. In the actual configuration, it is preferred that the inkjet head 202 have a larger number of nozzles 212 (for example, 100 or more nozzles 212).

In FIG. 2B, for the sake of illustration and description, an example of the arrangement of dots 302 in the case where a binary head is used as the inkjet head 202 is illustrated. In this case, for example, the binary head is an inkjet head in which the size of the dots 302 is fixed. For example, the size of the dots 302 is the size of the dots 302 on design. For example, the binary head can be regarded as an inkjet head in which only one kind of ejection amount can be set at normal ejection timing. For the inkjet head 202, for example, a multi-value head that is an inkjet head having the dots 302 of variable size may be used. The operation in the case where a multi-value head is used is described later in more detail.

FIG. 2B illustrates the relation between the interval of nozzles 212 in a nozzle row and the building resolution in the case where the interval of the nozzles 212 is larger than the distance corresponding to the building resolution in the sub scanning direction. More specifically, in the illustrated case, the interval of the nozzles 212 in the sub scanning direction is twice the distance corresponding to the building resolution in the sub scanning direction. Thus, in this case, the building apparatus 12 forms a single ink layer by the operation of a multi-pass method in which the main scanning operations are performed a plurality of times while the position of the inkjet head 202 in the sub scanning direction is shifted.

As described above, the inkjet head 202 in the head 102 ejects ink while moving in the main scanning direction in the main scanning operation. Accordingly, each of the nozzles 212 in the inkjet head 202 forms a line 304 in which dots 302 of ink are arranged in the main scanning direction. In this case, for example, the dot 302 means a dot of ink formed when ink ejected from one nozzle 212 is landed on a surface to be built of the product 50 at one ejection timing in the main scanning operation. In the present example, for example, the line 304 means the arrangement of dots 302 in which the dots 302 formed by ink ejected from one nozzle 212 in the single main scanning operation are arranged in the main scanning direction.

With such a configuration, for example, one line 304 is formed by each of the nozzles 212 in the inkjet head 202 in each main scanning operation. Accordingly, in each main scanning operation, the inkjet head 202 forms the lines 304 corresponding to the nozzles 212 so as to be arranged in the sub scanning direction. Accordingly, in each main scanning operation, the inkjet head 202 forms at least a part of the ink layer.

To build a product 50 with high accuracy, it is preferred that lines 304 constituting an ink layer be uniformly formed by using ink with the amount set in advance. The nozzles 212 in the inkjet head 202, however, have extremely fine configurations and hence the ejection amounts may vary. As a result, the line densities corresponding to the amounts of ink constituting the lines 304 may vary. In this case, for example, the line density is the amount of ink included in a unit length in one line 304. For example, the unit length of the line 304 is a range set in advance in the main scanning direction.

More specifically, in this case, for example, when any of the nozzles 212 in the inkjet head 202 is a defective nozzle (abnormal nozzle), the line density of a line 304 formed by the nozzle 212 varies, affecting the quality of building. In this case, for example, the defective nozzle is a nozzle whose ejection characteristics deviate from those of normal nozzles. For example, the normal nozzle is a nozzle in which the amount (ejection amount) of ink ejected from one nozzle 212 in one ejection operation falls within a standard range set in advance.

Note that, as described above, in the present example, the head 102 includes the planarizing roller 206 (see FIGS. 1A to 1C). Thus, for example, when there is a defective nozzle having a larger ejection amount, the influence on the quality of building can be suppressed by removing surplus ink by the planarizing roller 206. However, when there is a defective nozzle having a small ejection amount (for example, a non-ejection nozzle that does not eject ink), streaks may be generated due to insufficient ink at a position at which a line 304 should be formed by the nozzle. In this case, if ink layers are formed while being stacked, the influence of the defective nozzle may be increased.

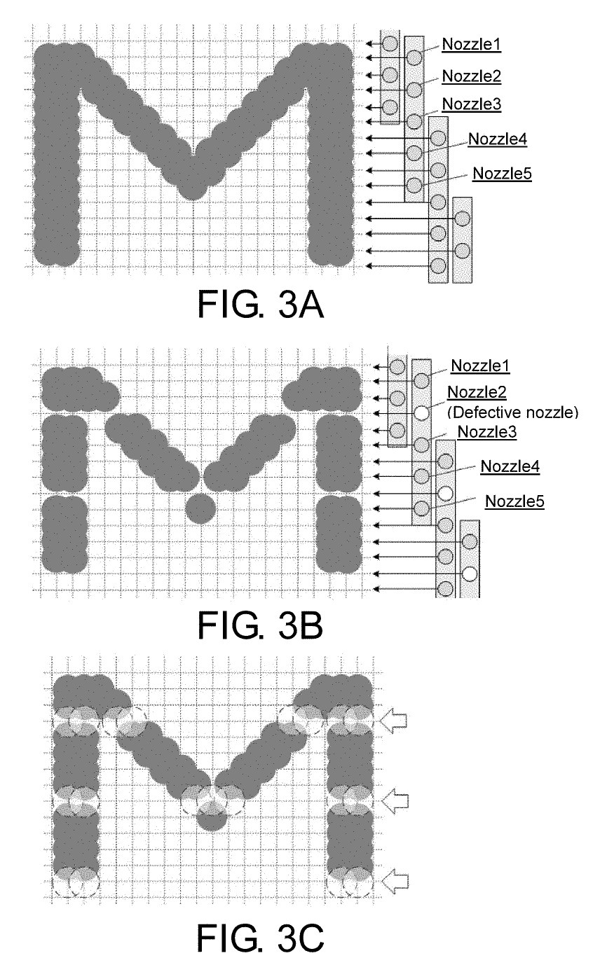

FIGS. 3A to 3C are diagrams for describing the influence of defective nozzles in more detail, and schematically illustrate the influence in the case where any of the nozzles is a non-ejection nozzle. In FIGS. 3A to 3C, for the sake of illustration, an example of the operation in which ink is ejected to a region having a thin line width of two dots is illustrated as the operation for forming an M-shaped ink layer. In the actual building of a product 50, however, for example, ink may be formed to a wider planar region.

FIG. 3A illustrates an example of arrangement of dots of ink formed by the main scanning operation when all nozzles in the inkjet heads are normal nozzles. In FIG. 3A, grids formed by vertical and horizontal lines represent ejection positions set in accordance with the building resolution. In this case, in each main scanning operation, each of the inkjet heads in the head 102 (see FIGS. 1A to 1C) ejects ink to ejection positions designated by slice data. In this manner, dots of ink necessary for building are formed at positions set in accordance with the building resolution.

In this case, the nozzles for ejecting ink to the positions in the main scanning operation are designated in the slice data by being assigned in advance by the control PC 14 (see FIGS. 1A to 1C). Thus, in the main scanning operation, each nozzle in the inkjet heads ejects ink to an ejection position designated in the slice data. In this case, the slice data is created in general on the assumption that all nozzles are normal nozzles. Thus, when all nozzles are actually normal, ink can be ejected to desired positions as illustrated in FIG. 3A.

However, in the case where any of the nozzles is a defective nozzle, even when ink is ejected from each nozzle in accordance with the slice data, ink cannot be ejected to some positions. FIG. 3B illustrates an example of arrangement of dots of ink formed by the main scanning operation when some nozzles in the inkjet heads are defective nozzles. More specifically, FIG. 3B illustrates an example of arrangement of dots of ink formed by the main scanning operation when nozzles represented by “nozzle 2” in FIG. 3B are non-ejection defective nozzles.

As illustrated in FIG. 3B, when any of the nozzles is a defective nozzle, ink is not properly ejected to ejection positions allocated to the nozzle. As a result, dots of ink cannot be properly formed on grids illustrated in FIG. 3B. More specifically, for example, when there is a non-ejection defective nozzle, dots are not formed at positions where dots should have been formed by the nozzle.

FIG. 3C is a diagram schematically illustrating the influence of defective nozzles, and the positions at which dots are not formed due to the defective nozzles in FIG. 3B are illustrated by circles. In this case, dots are not formed at positions as indicated by arrows in FIG. 3C, and hence gaps due to insufficient ink extend in the main scanning direction to generate streaks (white streaks). In the present example, on the other hand, the line densities of peripheral lines formed by defective nozzles are increased to suppress the influence of streaks. This operation is described below in more detail.

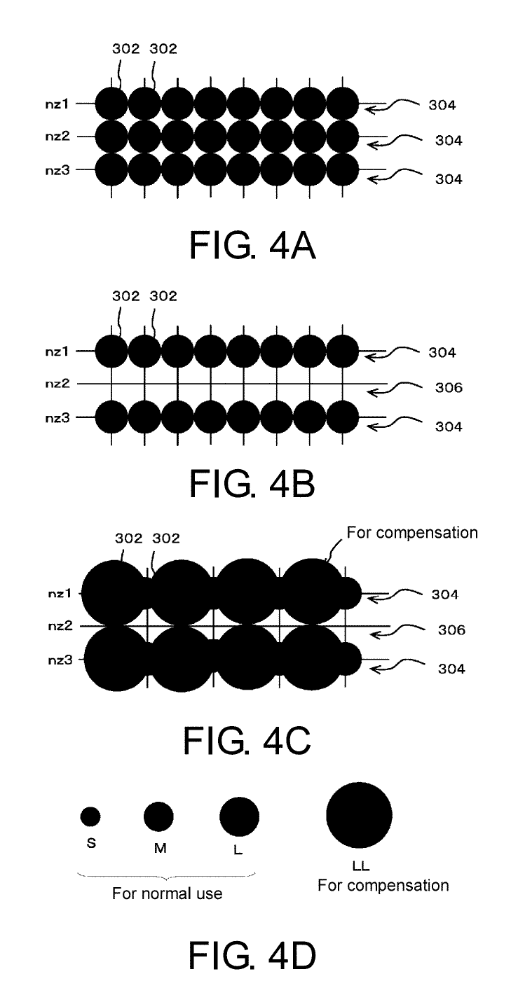

FIGS. 4A to 4D are diagrams for describing a method of suppressing the influence of defective nozzles in the present example in more detail, and schematically illustrate the basic concept of how to suppress the influence of defective nozzles. FIG. 4A is a diagram schematically illustrating lines 304 formed without defective nozzles, and schematically illustrates the states of three lines 304 arranged sequentially in the sub scanning direction among lines 304 formed during the formation of one ink layer. The three lines 304 are formed by different nozzles denoted by nz1 to nz3 in FIG. 4A.

FIG. 4B is a diagram schematically illustrating lines 304 formed in the state in which a non-ejection defective nozzle occurs, and schematically illustrates the states of lines 304 formed by the other nozzles (nz1, nz3) when the nozzle denoted by symbol nz2 in FIG. 4A is a non-ejection defective nozzle. As illustrated in FIG. 4B, in this case, dots that are originally intended to be formed are not formed by a nozzle at the position of the defective nozzle (nz2), and hence a streak 306 is formed due to the gap generated at the position of the corresponding line 304.

In the present example, on the other hand, in regard to the gap generated due to the defective nozzle, the amounts of ink ejected to form peripheral lines 304 are increased to reduce the influence on the quality of building. FIG. 4C schematically illustrates the state in which the peripheral lines 304 are formed so as to suppress the influence of the defective nozzle. As illustrated in FIG. 4C, in the present example, in the lines 304 near the streak 306 formed due to the defective nozzle, at least a part of dots constituting the lines 304 is increased such that the lines 304 are formed so as to fill (close) at least a part of the gap serving as the streak 306. For example, such a configuration can appropriately suppress the influence of the defective nozzle.

In the present example, for example, the peripheral lines 304 are lines 304 adjacent to a line 304 corresponding to a defective nozzle in the sub scanning direction. In this case, for example, the line 304 corresponding to the defective nozzle is a line 304 that should have been formed at the position of the defective nozzle. In order to build an object with higher accuracy, for example, the amount of ink may be adjusted for lines other than the lines 304 immediately adjacent to the position of the line 304 corresponding to the defective nozzle. How to select the peripheral lines 304 is described later in more detail. For example, the streak 306 formed due to the defective nozzle is a portion that serves as a gap unless the peripheral lines 304 are increased. Thus, the portion illustrated as the streak 306 in the state illustrated in FIG. 4C is not necessarily required to be an actual gap, but may be filled with dots on the peripheral lines 304.

To increase the amount of ink ejected to form a line 304 means, for example, to increase the line density of the line 304 to be larger than a normal-condition density. In regard to the line density, the normal-condition density means, for example, the line density of a line 304 formed by each nozzle when all nozzles in the inkjet head are normal nozzles.

In regard to the setting of the line density, in the present example, when all nozzles in the inkjet head are normal nozzles, the controller 110 (see FIGS. 1A to 1C) in the building apparatus 12 controls the inkjet head to perform the main scanning operation by setting the line density of a line 304 formed by each of the nozzles to be a normal-condition density set in advance. When any of the nozzles is a defective nozzle having a small ejection amount, the controller 110 controls the inkjet head to perform the main scanning operation by setting the line density of a line 304 formed by any of the nozzles other than the defective nozzle to be higher than the normal-condition density in at least some of the main scanning operations. In this case, for example, the defective nozzle having a small ejection amount is a defective nozzle whose ejection amount is smaller than a standard range set in advance.

More specifically, in this case, the controller 110 controls at least a part of dots for lines 304 adjacent to a position at which a line 304 should have been formed by the defective nozzle on both sides in the sub scanning direction to be formed large to increase the line densities. In this case, to increase the dots means, for example, to increase the ejection amount from a nozzle at the time of ejection of ink for forming the dots to be larger than in the normal case. With such a configuration, for example, even when the ejection amount of ink at positions corresponding to some lines 304 is small due to defective nozzles such as non-ejection nozzles, the insufficient amount can be appropriately compensated by ink ejected from other nozzles. Consequently, for example, in an ink layer, the generation of streaks due to insufficient ink can be appropriately suppressed.

As described above, in the present example, when an ink layer is formed, the planarizing roller 206 (see FIGS. 1A to 1C) is used to planarize the ink layer. Then, in this case, even when the ejection amounts of normal nozzles are increased to eject a large amount of ink, surplus ink can be appropriately removed. Thus, according to the present example, the ink layer can be appropriately formed with high accuracy.

Subsequently, the operation of increasing the line density of a particular line 304 is described in more detail. As described above, in the present example, in the case of increasing the line density of a line 304, the ejection amount for at least a part of dots constituting the line 304 is set to be larger than in the normal case to form larger dots. In this case, the normal case refers to, for example, the case where no defective nozzle is present. Examples of the method for forming a large dot by setting the ejection amount to be larger than in the normal case include a method for forming a large-sized dot that is not formed when there is no defective nozzle.

More specifically, in the present example, as the setting for increasing the line density, the setting for ejecting ink with an ejection amount larger than a normal-condition maximum ejection amount that is the maximum ejection amount in the normal operation is used. In this case, for example, the normal-condition maximum ejection amount is the maximum ejection amount in the case where no defective nozzle is present. In the case illustrated in FIGS. 4A to 4C, the ejection amount corresponding to the size of dots constituting the lines 304 formed in FIGS. 4A and 4B is the normal-condition maximum ejection amount. In this case, the ejection amount corresponding to large-sized dots (large droplets for compensation) denoted by “for compensation” in FIG. 4C is an ejection amount larger than the normal-condition maximum ejection amount. In this case, when all nozzles in the inkjet head are normal nozzles, in the main scanning operation, each of the nozzles ejects ink with an ejection amount equal to or smaller than the normal-condition maximum ejection amount. When any of the nozzles is a defective nozzle having a small ejection amount, at a timing of at least one of the main scanning operations, the controller 110 controls a nozzle for increasing the line density to be higher than the normal-condition density to eject ink with an ejection amount larger than the normal-condition maximum ejection amount.

FIGS. 4A to 4C illustrate lines 304 formed when a binary head is used as an inkjet head. Then, in this case, the ejection amount larger than the normal-condition maximum ejection amount may be an ejection amount larger than one type of the ejection amounts. Alternatively, as described above, for example, a multi-value head having the dots of variable size may be used as the inkjet head.

FIG. 4D illustrates an example of the sizes of dots formed when a multi-value head is used. In the case where a multi-value head is used as an inkjet head, when all nozzles in the inkjet head are normal nozzles, the controller 110 controls each of the nozzles in the inkjet head to eject ink with an ejection amount selected from a plurality of preset quantities of the ejection amount. In this case, the ejection amount larger than the normal-condition maximum ejection amount is an ejection amount larger than the maximum ejection amount among the plurality of quantities of the ejection amount. More specifically, in this case, in the normal case where no defective nozzle is present, for example, as illustrated in FIG. 4D, three different quantities of ejection amount corresponding to dots of three types of sizes of small (S), medium (M), and large (L) can be set. In this case, the ejection amount corresponding to the dot of large (L) size is the normal-condition maximum ejection amount.

In this case, as the ejection amount larger than the normal-condition maximum ejection amount used for compensation for the defective nozzle, as illustrated in FIG. 4D, an ejection amount corresponding to an LL size dot for compensation larger than the large (L) size dot is used. When there is a defective nozzle having a small ejection amount, at a timing of at least one of the main scanning operations, the controller 110 controls a nozzle for increasing the line density to be higher than the normal-condition density to eject ink with the ejection amount corresponding to the LL size dot. For example, such a configuration can appropriately suppress the influence of defective nozzles even when a multi-value head is used.

In a modification of how to change the line density, the setting of the dedicated ejection amount used for compensation is not necessarily required to be prepared, and the operation of the multi-value head may be used to suppress the influence of defective nozzles. More specifically, in this case, for example, in a line 304 whose line density is to be increased, the size of dots may be set to be larger than in the normal case at the time of forming at least a part of dots. In this case, for example, the size of dots in the normal case is the size of dots formed when there is no defective nozzle. In this case, at positions at which dots are formed with the small (S) size or the medium (M) size in the normal case, dots with the medium (M) size or the large (L) size, which are dots with sizes larger than one size or more, may be formed. In this case, a plurality of sizes may be mixed for dots whose size is to be increased. In this case, the dot size may be selected in consideration of the sizes of dots constituting each line such that the overlapping amount of dots is minimized.

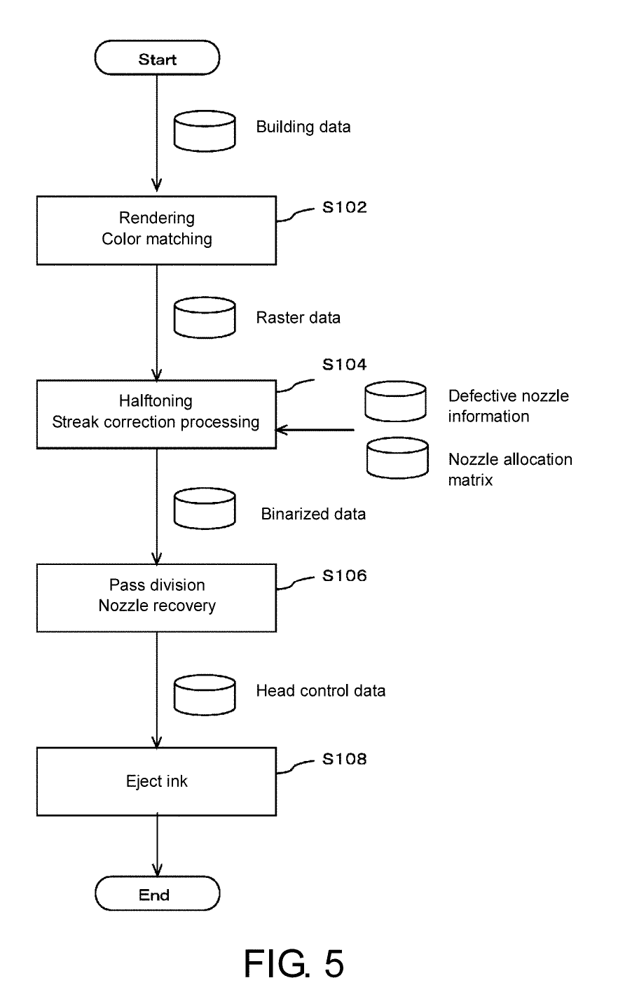

Subsequently, the overall operation of the building system 10 (see FIGS. 1A to 1C) in the present example, including the operation for generating slice data by the control PC 14 (see FIGS. 1A to 1C), is described in more detail. FIG. 5 is a flowchart illustrating an example of the operations of the building system 10 in the present example.

Note that the operations at Steps S102 and S104 among the operations illustrated in FIG. 5 are an example of operations performed by the control PC 14 in the building system 10. In the present example, examples of the operations performed by the control PC 14 at Steps 5102 and S104 include RIP processing for generating slice data supplied to the building apparatus 12. The operations at Steps S106 and S108 are an example of operations performed by the building apparatus 12 (see FIGS. 1A to 1C) in the building system 10.

In the building system 10 in the present example, when a product 50 is built, first, the control PC 14 generates slice data supplied to the building apparatus 12 based on building data. In this case, the building data is, for example, data indicating the shape and color of the product 50 to be built by the building apparatus 12. As the building data, for example, data in a general-purpose format independent from the model of the building apparatus 12 may be used.

In the processing for generating the slice data, the control PC 14 first performs rendering and color matching on building data (S102). In this case, for example, the control PC 14 receives the building data from another external computer, and performs rendering and color matching. In this manner, the control PC 14 generates raster data indicating cross-sections of the product 50 based on the building data. More specifically, in this case, for example, the control PC 14 calculates, based on the building data, the shape and color of the product at positions of ink layers deposited in the building apparatus 12. In the calculation operation, the control PC 14 performs rendering and color matching as appropriate. In this manner, the control PC 14 generates raster data corresponding to the ink layers.

Examples of the raster data corresponding to ink layers include data indicating colors of positions in ink layers. For example, the raster data may be data indicating the shapes and colors of cross sections of a product. For another example, the raster data may be slice data before being binarized.

After the operation at Step S102, the control PC 14 subjects the generated raster data to halftone processing (half toning) to generate binarized data obtained by binarizing raster data corresponding to each cross-section of the product (S104). In the present example, the control PC 14 further performs streak correction processing, which is processing for suppressing the influence of defective nozzles, in the processing for binarizing the raster data.

In this case, for example, the streak correction processing is processing for adjusting the binarized data such that the influence of defective nozzles can be suppressed by the method described above with reference to FIGS. 4A to 4D. More specifically, in the present example, the control PC 14 receives the defective nozzle information and the nozzle allocation matrix from the building apparatus 12, and performs the streak correction processing based on the defective nozzle information and the nozzle allocation matrix. In this case, for example, the defective nozzle information is information indicating a defective nozzle that is present in each inkjet head included in the head 102 (see FIGS. 1A to 10) in the building apparatus 12. As the defective nozzle information, for example, data indicating numbers (nozzle numbers) representing nozzles having small ejection amounts (non-ejection nozzles) in a list format can be suitably used. The nozzle allocation matrix is a matrix indicating nozzles allocated to pixels in the binarized data. As the nozzle allocation matrix, for example, a matrix in which the positions of pixels and the numbers of nozzles are associated with one another can be suitably used.

Pixels in the binarized data are, for example, positions corresponding to three-dimensional pixels set with intervals according to the building resolution in the arrangement of values constituting the binarized data. In the present example, as the binarized data, the control PC 14 generates, for each inkjet in the head 102, binarized data for each size of dots of ink formed to build an object.

More specifically, for example, in the present example, as described above, a part of dots of ink formed to build an object is formed in a manner that the ejection amount is set to be larger than in the normal case to form a large dot, thereby suppressing the influence of defective nozzles. Thus, in the streak correction processing, for example, in addition to binarized data for dots formed with the normal size, binarized data for large dots indicating the positions at which the large dots are formed is generated.

As described above, in the present example, the defective nozzle information and the nozzle allocation matrix are used to perform streak correction processing in the generation of the binarized data. In this case, the generated binarized data may be data (ejection position designation data) for designating a position at which ink is ejected from each nozzle in each inkjet head. Thus, in the present example, the binarized data is an example of the ejection position designation data. For another example, the binarized data may be slice data after binarization. In the present example, the control PC 14 supplies the binarized data to the building apparatus 12 as slice data.

The building apparatus 12 that has received the binarized data from the control PC 14 generates, based on the binarized data, head control data that is data for controlling the operation of each inkjet head in the head 102 (S106). In this case, for example, based on the setting of the main scanning operation actually performed for the building, the building apparatus 12 divides a pass for each ejection position designated in the binarized data. In this case, for example, the pass division means to set when to eject ink in the main scanning operation to positions in accordance with the number of passes that is the number of main scanning operations performed for each position in a layer during the formation of one ink layer.

In the case of building an object by a multi-pass method having a plurality of numbers of passes, when alternate nozzles can be set for at least some defective nozzles, the setting of the alternative nozzles (nozzle recovery) may be performed in the pass division. In this case, the streak correction processing described above is not necessarily required to be performed on a defective nozzle for which an alternate nozzle can be set. Thus, in this case, in the processing at Step S106 performed by the control PC 14, such a defective nozzle that can be replaced with the alternate one is not necessarily required to be treated as a defective nozzle. For example, such a configuration can more appropriately suppress the influence of defective nozzles by using the method of setting the alternate nozzle as well.

After head control data is generated by pass division, the controller 110 (see FIGS. 1A to 1C) in the building apparatus 12 controls each inkjet head to eject ink in accordance with the head control data (S108). For example, such a configuration can control each inkjet head to appropriately eject ink to each ejection position designated in binarized data received by the building apparatus 12. Consequently, for example, a product can be appropriately built.

Subsequently, the halftone processing performed in the control PC 14 is described in more detail. In the present example, in the operation for generating binarized data, the control PC 14 subjects a portion corresponding to at least part of the product to halftone processing by using error diffusion or dithering. In this case, as described above, the processing for suppressing the influence of defective nozzles is further performed.

Then, in this case, when error diffusion or dithering is simply applied, defective nozzles to be controlled not to eject ink are also subjected to the processing of error diffusion or dithering. However, in order to more appropriately perform the halftone processing when there is a defective nozzle controlled not to eject ink, it is preferred to perform the processing in consideration that the defective nozzle is controlled not to eject ink. Thus, the halftone processing in the present example uses error diffusion or dithering by excluding a position at which ink is ejected from the defective nozzle. In this case, the position at which ink is ejected from the defective nozzle is, for example, a position at which ink is ejected if the defective nozzle were a normal nozzle (original ejection position). For example, such a configuration can more appropriately perform the halftone processing suited to the state in which the defective nozzle is present.

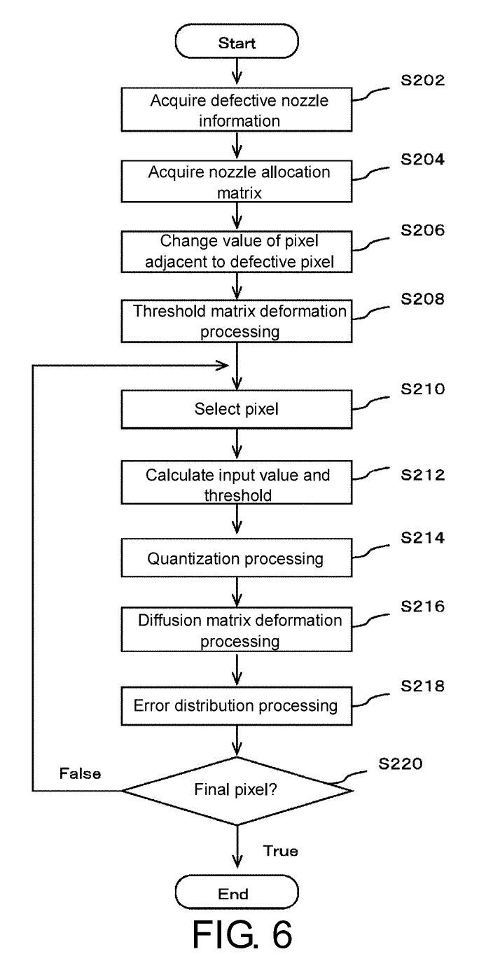

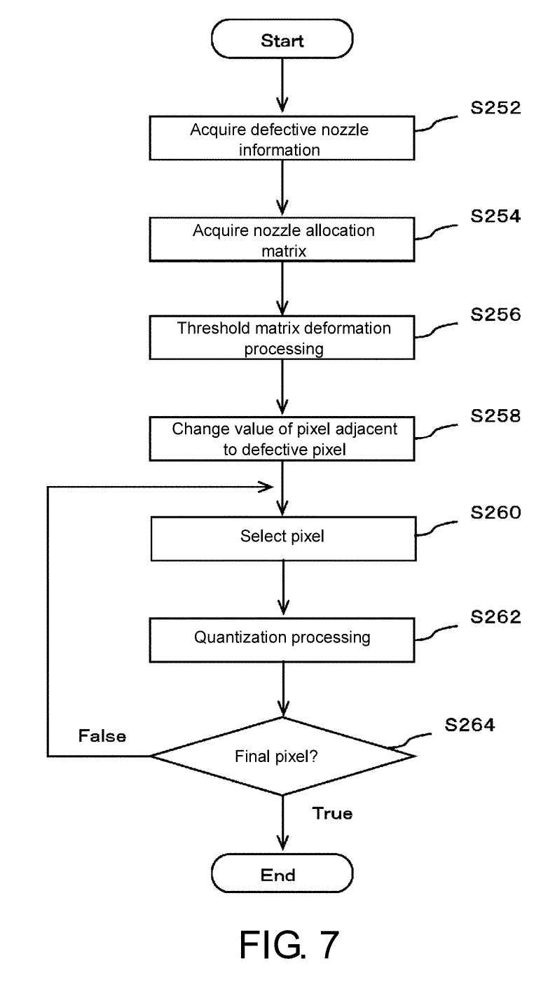

FIG. 6 and FIG. 7 are diagrams for describing the halftone processing performed in the present example in more detail. First, halftone processing using error diffusion is described.

FIG. 6 illustrates an example of halftone processing using error diffusion. In this case, first, the control PC 14 communicates with the building apparatus 12 to acquire defective nozzle information (S202) and a nozzle allocation matrix (S204). Then, the pixel value of a pixel adjacent to a defective pixel that is a pixel corresponding to a defective nozzle is changed to be increased (S206). In this case, the pixel corresponding to the defective nozzle is, for example, a pixel at a position associated with the defective nozzle in raster data before binarization. Pixels in the raster data are, for example, pixels at positions corresponding to positions of three-dimensional pixels constituting a product. The pixel adjacent to the defective pixel is, for example, a pixel adjacent to the defective pixel in the sub scanning direction within the same cross-section in the product.

After the pixel value of the adjacent pixel is changed, the control PC 14 subjects a threshold matrix (dither matrix) indicating a threshold used for quantization processing to threshold matrix deformation processing that is deformation processing taking defective nozzle into consideration. The threshold matrix deformation processing is described later in more detail.

The deformed threshold matrix is used to quantize pixels in the raster data. In this case, the quantization means to binarize pixels for each size of dots used for the building. In the quantization processing, first, a pixel is selected (S210), and an input value of the pixel and a threshold are calculated (S212). The input value and the threshold are compared to quantize the pixel (S214). Diffusion matrix deformation processing (S216), which is processing for deforming the diffusion matrix for diffusing errors, and error distribution processing (S218) for distributing errors are further performed. The diffusion matrix deformation processing is also described later in more detail.

When the pixel being processed is not the last pixel (final pixel) (False at S220), the processing returns to Step S210 to select the next pixel, and the subsequent operation is repeated. At Step S220, when the pixel being processed is the final pixel (True at S220), the processing is finished. Such a configuration can appropriately perform the halftone processing using error diffusion.

Subsequently, halftone processing using dithering is described. FIG. 7 illustrates an example of halftone processing using dithering. Also in this case, first, the control PC 14 acquires defective nozzle information (S252) and a nozzle allocation matrix (S254). Threshold matrix deformation processing (S256) is performed to change a pixel value of a pixel adjacent to a defective pixel, which is a pixel corresponding to a defective nozzle, to be increased (S258).

In this case, for example, the operations at Steps S252, S254, S256, and S258 can be performed in the same or similar manner to the operations at Steps S202, S204, S208, and S206 illustrated in FIG. 6. In regard to the order of Step S256 and Step 258, the operation at Step S258 may be performed first similarly to the order of Step S206 and Step S208 in FIG. 6. In the operations in FIG. 6, the operation at Step S208 may be performed before the operation at Step S206.

After the operation at Step S258 is performed, the control PC 14 quantizes pixels in raster data. In the quantization processing, first, a pixel is selected (S260), and the quantization processing based on dithering is performed (S262). When the pixel being processed is not the last pixel (final pixel) (False at S264), the processing returns to Step S260 to select the next pixel, and the subsequent operation is repeated. At Step S260, when the pixel being processed is the final pixel (True at S264), the processing is finished. Such a configuration can appropriately perform the halftone processing using dithering.

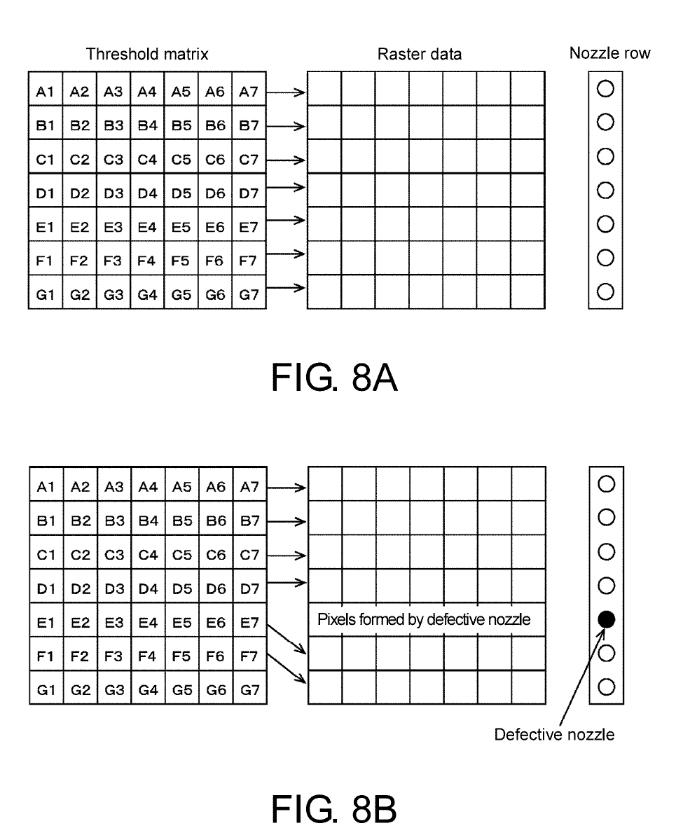

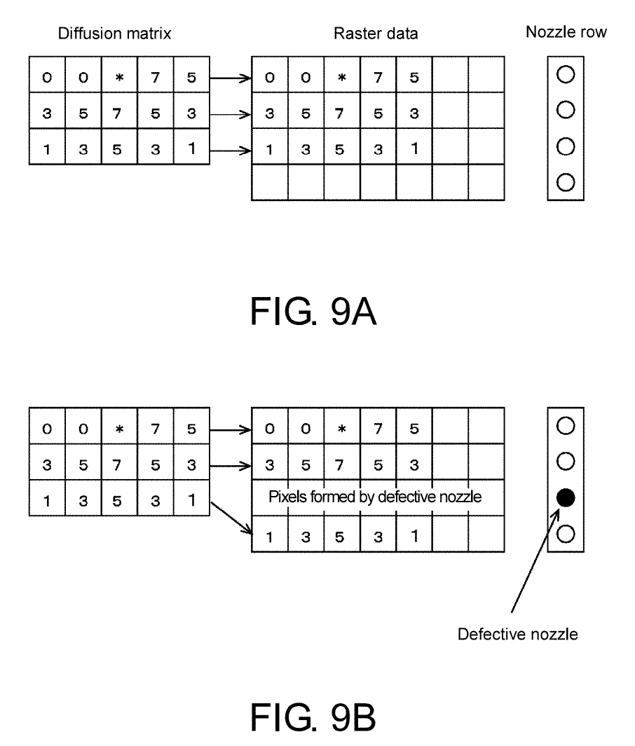

Subsequently, the threshold matrix deformation processing and the diffusion matrix deformation processing are described in more detail. FIGS. 8A and 8B and FIGS. 9A and 9B are diagrams for describing the threshold matrix deformation processing and the diffusion matrix deformation processing in more detail, and schematically illustrate an example of the threshold matrix deformation processing and the diffusion matrix deformation processing performed in consideration of defective nozzles.

FIGS. 8A and 83 are diagrams for describing the threshold matrix deformation processing in more detail. FIG. 8A illustrates an example of a threshold matrix (dither matrix) before being deformed. FIG. 83 illustrates an example of the threshold matrix deformation processing performed in consideration of defective nozzles. In FIG. 83, a nozzle represented by a circle filled in black in a schematically illustrated nozzle row is a defective nozzle.

As described above, in the present example, a product is built in a manner that ink is not ejected from a defective nozzle having a small ejection amount. Thus, in raster data or binarized data, a defective pixel corresponding to the defective nozzle is a pixel in which a dot of ink is not formed. In the present example, the threshold matrix is deformed such that the defective pixel is not allocated with a value in the threshold matrix. More specifically, in this case, the value in the threshold matrix that is originally intended to be allocated to the defective pixel is shifted to the next pixel as illustrated in FIG. 8B.

For example, the threshold matrix is designed in consideration of the number and positions of dots formed per unit length. However, when a defective pixel is present and a dot of ink is not formed at the original position, the continuity and the positional relation necessary as a matrix may be greatly impaired. On the other hand, by deforming the threshold matrix as described above such that the value in the matrix is not allocated to the defective pixel, such a problem can be appropriately suppressed.

As described above, in the present example, the diffusion matrix is also deformed in consideration of defective nozzles. FIGS. 9A and 9B are diagrams for describing the diffusion matrix deformation processing in more detail. FIG. 9A illustrates an example of a diffusion matrix before being deformed. FIG. 9B illustrates an example of the diffusion matrix deformation processing performed in consideration of defective nozzles. In FIG. 9B, a nozzle represented by a circle filled in black in a schematically illustrated nozzle row is a defective nozzle.

In the present example, as described above, the defective nozzle is set not to eject ink. Thus, error distribution processing is set such that an error is not distributed to a defective pixel. More specifically, in this case, as illustrated in FIG. 9B, errors are distributed to pixels other than the defective pixel by excluding the defective pixel.

In error diffusion, an error that occurs when a given pixel is quantized is distributed to peripheral unprocessed pixels based on the diffusion matrix. In this case, the error is distributed to determine the continuity of dots and the positional relation of dots. On other hand, for example, if an error is distributed to a defective pixel, a dot that should have been formed is not formed, and hence the continuity of flow of errors may be impaired. As a solution, by performing the diffusion matrix deformation processing as described above, such a problem can be appropriately suppressed.

As described above, according to the present example, for example, the threshold matrix deformation processing and the diffusion matrix deformation processing are performed such that the continuity of dots to be formed can be more appropriately increased. Consequently, for example, an object can be built with higher accuracy.

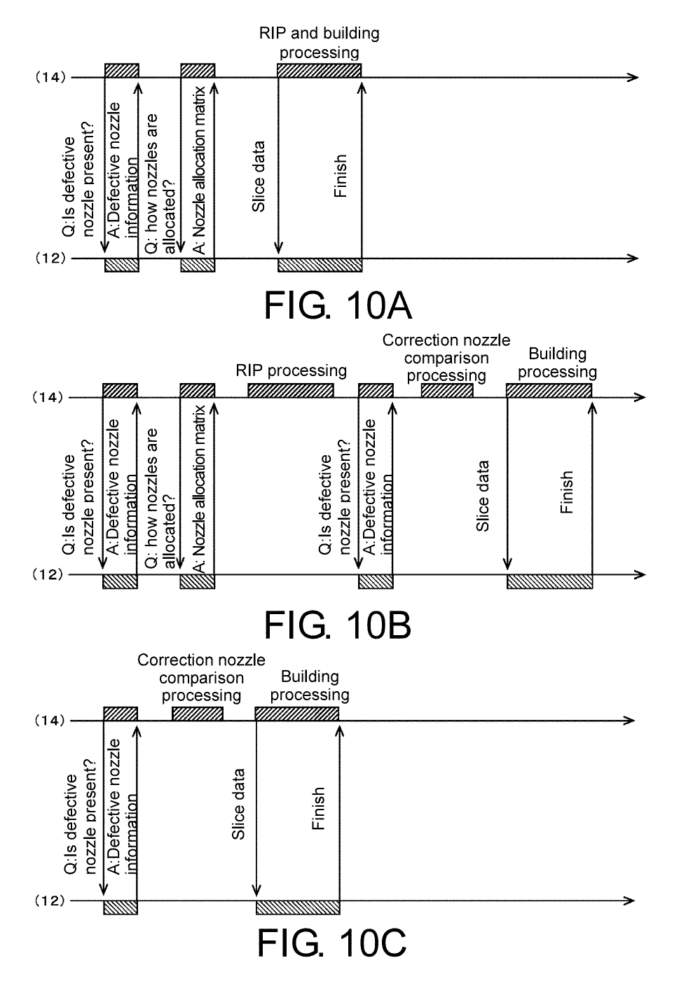

Subsequently, the operation performed by the building apparatus 12 and the control PC 14 in a cooperative manner in the building system 10 in the present example is described in more detail. FIGS. 10A to 10C are diagrams for describing the communication performed between the building apparatus 12 and the control PC 14 in more detail. FIGS. 10A to 100 illustrate an example of communication performed between the building apparatus 12 and the control PC 14 in the case where objects are built at various timings. In FIGS. 10A to 10C, operations indicated by RIP or RIP processing are the operations corresponding to Steps S102 and 5104 illustrated in FIG. 5. The building processing is the operation corresponding to Steps S106 and S108 illustrated in FIG. 5.

As described above, in the present example, the control PC 14 generates binarized slice data (binarized data), and the building apparatus 12 builds a product 50 based on the data. At the time of generating the slice data by the control PC 14, data is processed in consideration of defective nozzles. Thus, at the time of generating the slice data, the control PC 14 needs to grasp the state of defective nozzles in the building apparatus 12. Thus, in the present example, as described above, the building apparatus 12 and the control PC 14 communicate with each other such that defective nozzle information and a nozzle allocation matrix are transmitted from the building apparatus 12 to the control PC 14.

In the case where a product is actually built, the generation of slice data by the control PC 14 and the building operation by the building apparatus 12 are not necessarily required to be performed successively. After the slice data is generated by the control PC 14, the building apparatus 12 may build an object after a while. In this case, a defective nozzle taken into consideration for generating the slice data by the control PC 14 and a defective nozzle that is actually present during the building by the building apparatus 12 do not always match with each other.

For example, a nozzle that was normal when slice data was generated by the control PC 14 becomes a defective nozzle when building is executed by the building apparatus 12. For another example, a nozzle that was a defective nozzle when slice data was generated by the control PC 14 is recovered to a normal nozzle when building is executed. In such cases, a nozzle to be subjected to streak correction processing is changed, and hence the influence of defective nozzles cannot be appropriately suppressed depending on cases. Thus, in cases other than the case where the generation of slice data by the control PC 14 and the building operation by the building apparatus 12 are successively performed, it is preferred to confirm that the slice data properly corresponds to a defective nozzle that is present at that time. In this case, the building apparatus 12 may make an inquiry to the control PC 14 as necessary.

More specifically, FIG. 10A illustrates an example of communication performed between the building apparatus 12 and the control PC 14 when the generation of slice data by the control PC 14 and the operation of building by the building apparatus 12 are successively performed. In this case, in the processing for generating the slice data, the control PC 14 inquires the building apparatus 12 of whether there is a defective nozzle. In this case, in response to the inquiry, the building apparatus 12 transmits defective nozzle information to the control PC 14. The control PC 14 further inquires the building apparatus 12 of how to allocate nozzles. Then, in response to the inquiry, the building apparatus 12 transmits a nozzle allocation matrix to the control PC 14.

After these communications are performed, the control PC 14 performs processing for generating binarized slice data by reflecting the information on the defective nozzle. For example, the generated slice data are sequentially transmitted to the building apparatus 12. For example, the building apparatus 12 builds objects based on the slice data sequentially received from the control PC 14. At the time when the building is completed, the building apparatus 12 notifies the control PC 14 of the completion of the building.

For example, such a configuration can appropriately build a product. In this case, the generation of the slice data by the control PC 14 and the building operation by the building apparatus 12 are performed successively, and hence it is not necessary to check the correspondence between the slice data and the defective nozzle. By contrast, when only the slice data is first generated by the control PC 14 and thereafter the building apparatus 12 builds an object at another timing, it is preferred to check the correspondence between the slice data and the defective nozzle as described above.

FIG. 10B illustrates an example of communication performed between the building apparatus 12 and the control PC 14 in the case where only slice data is first generated by the control PC 14 and thereafter the building apparatus 12 builds an object at another timing. Also in this case, in the processing for generating the slice data, the control PC 14 inquires the building apparatus 12 of whether there is a defective nozzle and how to allocate nozzles. In response to the inquiries, the building apparatus 12 transmits defective nozzle information and a nozzle allocation matrix. After these communications are performed, the control PC 14 performs processing for generating binarized slice data by reflecting the information on the defective nozzle.

In this case, the building apparatus 12 starts the building operation at any timing after the completion of the generation of the slice data by the control PC 14. In this case, in the communication performed between the building apparatus 12 and the control PC 14, the control PC 14 inquires the building apparatus 12 of whether there is a defective nozzle again. In response to the inquiry, the building apparatus 12 transmits defective nozzle information to the control PC 14.

Then, in this case, the control PC 14 performs correction nozzle comparison processing, which is processing for comparing the generated slice data and the defective nozzle information to each other. In this manner, it is checked whether the defective nozzle taken into consideration for generating the slice data and the defective nozzle indicated in the defective nozzle information match with each other (checking of matching of defective nozzles).

When the matching of the defective nozzles has been confirmed, the slice data is transmitted from the control PC 14 to the building apparatus 12 to execute the building by the building apparatus 12. In the confirming of the matching of the defective nozzles, when it is determined that the defective nozzles do not match with each other, for example, the control PC 14 generates new slice data based on newly acquired defective nozzle information. In this case, the new slice data is transmitted to the building apparatus 12 to cause the building apparatus 12 to build an object. Such a configuration can appropriately confirm the use of correct slice data suited for a defective nozzle present in the building.

For example, the building apparatus 12 may build an object by using slice data generated in the past as illustrated in FIG. 10C. Then, in this case, only the latter half of the operation illustrated in FIG. 10B may be performed. Also in this case, by confirming the matching of the defective nozzles before the building, the use of proper slice data suited for the defective nozzle that is present during the building can be appropriately confirmed.

In the present example, the operation of checking the matching of the defective nozzles is the checking operation performed before the building apparatus 12 starts the building operation as described above. In the cases illustrated in FIGS. 10B and 1° C., the specific confirmation operation is performed by the control PC 14. In regard to the confirming operation, when the operation of the building apparatus 12 is focused, whether the defective nozzles match with each other is confirmed also on the building apparatus 12 side by communicating with the control PC 14. In this case, for example, the controller 110 (see FIGS. 1A to 1C) in the building apparatus 12 communicates with the control PC 14 to check whether a defective nozzle present in the inkjet head of the head 102 (FIGS. 1A to 1C) in the building apparatus 12 and a defective nozzle taken into consideration for generating the slice data by the control PC 14 are the same. In the present example, when the matching of the defective nozzles cannot be confirmed, new slice data is generated by the control PC 14 as described above. In a modification of the operations of the building apparatus 12 and the control PC 14, for example, the building operation is not necessarily required to be started when the matching of the defective nozzles has not been confirmed, and the building apparatus 12 may build an object only when the matching has been confirmed.

In the present example, the slice data generated by the control PC 14 in consideration of defective nozzles is an example of defective nozzle presence data that is ejection position designation data generated in consideration of defective nozzles. In this case, for example, the control PC 14 generates defective nozzle presence data in which the defective nozzle is controlled not to eject ink and the line density of a line formed by any nozzle other than the defective nozzle is set to be higher than the normal-condition density. In this case, for example, the controller 110 in the building apparatus 12 controls each of the nozzles in the inkjet head to eject ink based on the defective nozzle presence data to set the line density of the line formed by any nozzle other than the defective nozzle to be higher than the normal-condition density. For example, such a configuration can appropriately suppress the influence of defective nozzles.

Subsequently, supplemental description is given on the streak correction processing performed in the present example. First, how to select a line whose line density is to be increased is described in more detail. In the above, with reference to FIGS. 4A to 4D, the case where a line immediately adjacent to the position of a line corresponding to a defective nozzle (hereinafter referred to as “defective line”) is selected as a line whose line density is to be increased among lines formed by nozzles other than the defective nozzle has been described.

In regard to this point, for example, in the case of building an object by the multi-pass method, such an adjacent line is not always formed by the same main scanning operation as a main scanning operation in which the defective line is intended to be formed. Thus, in this case, the adjacent line may be selected in consideration of the operation of the multi-pass method.

More specifically, for example, the interval of the nozzles in the inkjet head (interval in sub scanning direction) is an integer multiple of the building resolution in the sub scanning direction, and when one ink layer is formed by the multi-pass method, lines adjacent in the sub scanning direction in one ink layer are formed by the main scanning operation at a different time. In such a configuration, when a defective nozzle having a small ejection amount is present, in the main scanning operation in which a line adjacent to a defective line in the sub scanning direction among the lines constituting one ink layer is formed, the line density of the adjacent line may be set to be higher than the normal-condition density. In this case, for example, the line density of a nozzle that actually forms a line adjacent to a line corresponding to the defective nozzle instead of a nozzle adjacent to the defective nozzle in a nozzle row in the inkjet head may be set to be higher than the normal-condition density. For example, such a configuration can appropriately increase the line density of a line adjacent to the defective line in one layer. Consequently, for example, the influence of defective nozzles can be appropriately suppressed.

For a line adjacent to the defective line, the main scanning operation instead of each ink layer can be regarded as a unit. In this case, a line formed by a nozzle adjacent to a defective nozzle in a nozzle row in each inkjet head can be regarded as the line adjacent to the defective line. More specifically, in this case, the line density of the line formed by the nozzle adjacent to the defective nozzle in the sub scanning direction in the nozzle row may be set to be higher than the normal-condition density. For example, even such a configuration can appropriately suppress the influence of defective nozzles.

In order to suppress the influence of defective nozzles, the line density may be increased for another line without being limited to the adjacent line. In this case, for example, the line density of a line located at a position that sandwiches one line with a defective line in the sub scanning direction may be set to be higher than the normal-condition density. When a line is selected with the main scanning operation as a unit, for example, such a line is a line formed by a nozzle located at a position that sandwiches one nozzle with a defective nozzle in the sub scanning direction.

In regard to the adjustment of the line density, for example, an average line density in a group of lines set in advance may be adjusted for each group. In this case, for example, about three or five sequential lines in which a defective line is located at the center in the sub scanning direction may be grouped to adjust the average line density.

The operation of adjusting the line density for each group as described above may be, for example, an operation of selecting a plurality of nozzles for one defective nozzle and changing a corresponding line density. For another example, the operation may be an operation of adjusting an average line density in a plurality of lines including a line formed by the defective nozzle and a line formed by one or more normal nozzles to fall within a range set in advance. In this case, for example, the line density of a line formed by any of normal nozzles may be set to be higher than the normal-condition density.

In this case, it is preferred to adjust the line density by determining the sizes of dots constituting peripheral lines so as to minimize an error in amount (error in volume) of ink caused due to the presence of defective nozzles. In this case, the line density may be adjusted to be smaller for some lines in a group. For example, such a configuration can more flexibly adjust the average line density in the group. In a modification of how to adjust the line density, for example, when a defective nozzle having a large ejection amount is present, the line densities of lines near a defective line may be adjusted to be decreased.

A group of nozzles for which the average line density is calculated may be set in consideration of the operation of the multi-pass method. In this case, for example, a group including nozzles configured to form lines arranged sequentially in the sub scanning direction in one ink layer is set, and the average line density in the group is set to fall within a predetermined range. In the above, the case where the line densities of lines on both sides of a defective line (on both sides in sub scanning direction) are increased has been described. However, a line on only one side of a defective line in the sub scanning direction may be selected as the line whose line density is changed.

Subsequently, supplemental description is given on the adjustment of the line density. As described above, in the present example, the line density is increased by forming a line including large-sized dots for compensation. In this case, all dots in the line do not need to be increased in size, but some of the dots constituting the line may be increased in size. In this case, it is preferred that the proportion of dots increased in size be set such that the average ink amount (ejection amount) per unit area falls within a predetermined range.

For example, it is preferred that how large the line density is set be adjusted in accordance with building conditions (such as ink to be used). In this case, for example, an object may be built with a test pattern set in advance, and such line density that can suppress the influence of defective nozzles may be applied.

To suppress the influence of a defective nozzle having a small ejection amount, the concentration of peripheral ink may be increased by some method without being limited to the method described above. In regard to this point, when the method for increasing the line density is more generalized, this method is not limited to the method for increasing the dot size but may be a method for increasing the number of dots by some method. More specifically, for example, at the time of forming lines by some nozzles, dots may be arranged at reduced intervals in the main scanning direction so as to increase the line density.

As described above, in the present example, the building apparatus 12 builds a product having various regions as illustrated in FIGS. 2A and 2B. In this case, the line density described above may be adjusted at the time of forming each portion of the product. More specifically, the adjustment of the line density may be applied, for example, at the time of forming a single-material region that is a region formed of only one kind of ink in the product. In this case, for example, the single-material region is a region formed of only one kind of ink, such as an interior region, a light-reflective region, or a protective region, in the product. In this case, an inkjet head subjected to line density adjustment is an inkjet head configured to eject ink for such a single-material region.

The single-material region may be formed with a large ejection amount by using only one kind of ink. Thus, the formation of such a region is liable to be more affected by defective nozzles. On the other hand, in such a region, even when the ejection amounts of ink to the periphery of the defective line are increased, the quality of the building is less affected. Thus, in such a region, the influence of defective nozzles can be more appropriately suppressed by adjusting the line density as described above.

The adjustment of the line density may be applied at the time of forming a region formed with use of kinds of ink, such as a colored region, in the product. More specifically, in this case, an inkjet head subjected to line density adjustment is an inkjet head configured to coloring ink. In forming the colored region, the halftone processing performed in the control PC 14 is particularly important. Thus, in this case, it is particularly preferred to perform the threshold matrix deformation processing and the diffusion matrix deformation processing described in the above.

Subsequently, supplemental description is given on the effects obtained in the present example. As described above, in the present example, the line densities of lines formed by nozzles on both sides of a defective nozzle are increased to increase the concentration of ink near (for example, on both sides of) a defective line in the sub scanning direction. Consequently, for example, the influence of defective nozzles can be suppressed to appropriately prevent the occurrence of streaks and the like due to the insufficient amount of ink.

In this regard, in order to suppress the influence of defective nozzles, for example, the position of the inkjet head in the sub scanning direction may be shifted for each ink layer to be deposited such that lines overlapping with each other at the same position are formed by nozzles different for each layer. In this case, however, the control of the position of the inkjet head may be complicated. Even when the position is shifted, streak and the like may be generated at the time of forming the ink layers. As a result, the quality of the building may be affected. In the present example, on the other hand, for example, the influence of defective nozzle can be appropriately suppressed without performing the control of shifting the position of the inkjet head in the sub scanning direction for each layer. Consequently, for example, the influence of defective nozzles can be more appropriately suppressed by simpler control.

The disclosure can be suitably used for, for example, a building apparatus.

What is claimed is:

1. A building apparatus configured to build a product which is three-dimensional by additive manufacturing, comprising:
an ejection head having a plurality of nozzles each configured to eject a building material as a material used for building;
a scan driver configured to control the ejection head to perform a main scanning operation in which the building material is ejected from the plurality of nozzles while the ejection head moves in a main scanning direction set in advance relatively to the product being built; and
a controller configured to control operations of the ejection head and the scan driver, wherein
the ejection head includes the plurality of nozzles arranged at positions shifted from one another in a sub scanning direction orthogonal to the main scanning direction,
in a case where an arrangement of dots formed by the building material ejected from one of the plurality of nozzles in a single main scanning operation is defined as a line, an amount of the building material included in a unit length in the line is defined as a line density, a nozzle of the plurality of nozzles in which an ejection amount that is the amount of the building material ejected from one of the plurality of nozzles in one of the ejection operations falls within a standard range set in advance is defined as a normal nozzle, and a nozzle of the plurality of nozzles other than the normal nozzle is defined as a defective nozzle,
when all of the plurality of nozzles in the ejection head are the normal nozzles, the controller controls the ejection head to perform the main scanning operation by setting the line density of the line formed by each of the plurality of nozzles to be a normal-condition density set in advance, and
when the defective nozzle in which the ejection amount is smaller than the standard range is present in the plurality of nozzles in the ejection head, the controller controls the ejection head to perform the main scanning operation by setting the line density of the line formed by any of the plurality of nozzles other than the defective nozzle to be higher than the normal-condition density in at least some of the main scanning operations.

2. The building apparatus according to claim 1, wherein when the defective nozzle having a small ejection amount is present, the controller sets the line density of the line formed by the plurality of nozzles adjacent to the defective nozzle in the sub scanning direction to be higher than the normal-condition density.

3. The building apparatus according to claim 1, wherein when the defective nozzle having a small ejection amount is present, the controller sets the line density of the line formed by the plurality of nozzles located at a position that sandwiches one of the plurality nozzles with the defective nozzle in the sub scanning direction to be higher than the normal-condition density.

4. The building apparatus according to claim 1, wherein
at a time of forming each of layers to be deposited by additive manufacturing, the layers are formed by an operation of a multi-pass method in which a plurality of times of the main scanning operation are performed for each position on the layers,
an interval of the plurality of nozzles in the ejection head in the sub scanning direction is an integer multiple of a building resolution in the sub scanning direction,
the line adjacent in the sub scanning direction in one of the layers is formed by the main scanning operation at a different time and
when the defective nozzle having a small ejection amount is present, the controller sets the line density of an adjacent line adjacent to a line corresponding to the defective nozzle in the sub scanning direction to be higher than the normal-condition density in the main scanning operation in which the adjacent line is formed.

5. The building apparatus according to claim 1, wherein when the defective nozzle having a small ejection amount is present, the controller sets the line density of the line formed by at least one of the normal nozzles to be higher than the normal-condition density such that an average of the line density of a plurality of the lines including a line formed by the defective nozzle and a line formed by any of one or more of the normal nozzles falls within a range set in advance.

6. The building apparatus according to claim 1, wherein
when all of the plurality of nozzles in the ejection head are the normal nozzles, each of the plurality of nozzles in the ejection head ejects the building material with an ejection amount equal to or smaller than a normal-condition maximum ejection amount that is a maximum ejection amount set in advance, and
when the defective nozzle having a small ejection amount is present, at a timing of at least one of the main scanning operations, the controller controls a nozzle of the plurality of nozzles configured to increase a corresponding line density to be higher than the normal-condition density to eject the building material with an ejection amount larger than the normal-condition maximum ejection amount.

7. The building apparatus according to claim 6, wherein
when all of the plurality of nozzles in the ejection head are the normal nozzles, the controller controls each of the plurality of nozzles in the ejection head to eject the building material with an ejection amount selected from a plurality of quantities of the ejection amount set in advance, and
when the defective nozzle having a small ejection amount is present, at a timing of at least one of the main scanning operations, the controller controls a nozzle of the plurality of nozzles configured to a corresponding line density to be higher than the normal-condition density to eject the building material with an ejection amount larger than a maximum ejection amount among the plurality of quantities of the ejection amount.

8. The building apparatus according to claim 1, further comprising a planarizing roller configured to planarize a layer of the building material.

9. The building apparatus according to claim 1, wherein
the building apparatus builds the product including a single-material region that is a region formed of only one kind of the building material, and
the ejection head is an ejection head used to form the single-material region.

10. The building apparatus according to claim 1, wherein
the building apparatus builds the product in which at least a part is colored with a building material for coloring, and
the ejection head is an ejection head configured to eject the building material for coloring.

11. The building apparatus according to claim 1, wherein
in the main scanning operation, the controller controls each of the plurality of nozzles in the ejection head to eject the building material based on an ejection position designation data which is a data for designating a position where the building material is ejected from each of the plurality of nozzles in the ejection head,
the ejection position designation data is a data generated by subjecting a portion corresponding to at least part of the product to halftone processing by using error diffusion or dithering, and
when the defective nozzle having a small ejection amount is present, in the halftone processing, error diffusion or dithering is used while excluding a position at which the building material is ejected from the defective nozzle.

12. The building apparatus according to claim 11, wherein
the building apparatus receives the ejection position designation data which is the data for designating a position at which the building material is ejected from each of the plurality of nozzles in the ejection head, from a data generation apparatus configured to generate the ejection position designation data,
in the main scanning operation, the controller controls each of the plurality of nozzles in the ejection head to eject the building material based on the ejection position designation data,
when the defective nozzle having a small ejection amount is present, the data generation apparatus generates a defective nozzle presence data which is the ejection position designation data for controlling the defective nozzle not to eject the building material and setting the line density of the line formed by any of the plurality of nozzles other than the defective nozzle to be higher than the normal-condition density, and
the controller controls each of the plurality of nozzles to eject the building material based on the defective nozzle presence data to set the line density of the line formed by any of the plurality of nozzles other than the defective nozzle to be higher than the normal-condition density.

13. The building apparatus according to claim 12, wherein when the defective nozzle having a small ejection amount is present, before the building apparatus starts a building operation, the controller checks whether the defective nozzle present in the ejection head and the defective nozzle taken into consideration for generating the ejection position designation data are the same.

14. The building apparatus according to claim 13, wherein the controller communicates with the data generation apparatus to check whether the defective nozzle present in the ejection head and the defective nozzle taken into consideration for generating the ejection position designation data are the same.

15. A building method for building a product which is three-dimensional by additive manufacturing, comprising:
controlling an ejection head having a plurality of nozzles each configured to eject a building material as a material used for building to perform a main scanning operation in which the building material is ejected from the plurality of nozzles while the ejection head moves in a main scanning direction set in advance relatively to the product being built,
the ejection head including the plurality of nozzles arranged at positions shifted from one another in a sub scanning direction orthogonal to the main scanning direction;
in a case where an arrangement of dots formed by the building material ejected from one of the plurality of nozzles in a single main scanning operation is defined as a line, an amount of the building material included in a unit length in the line is defined as a line density, a nozzle of the plurality of nozzles in which an ejection amount that is the amount of the building material ejected from one of the plurality of nozzles in one of the ejection operations falls within a standard range set in advance is defined as a normal nozzle, and a nozzle of the plurality of nozzles other than the normal nozzle is defined as a defective nozzle,
controlling, when all of the plurality of nozzles in the ejection head are the normal nozzles, the ejection head to perform the main scanning operation by setting the line density of the line formed by each of the plurality of nozzles to be a normal-condition density set in advance; and
controlling, when the defective nozzle in which the ejection amount is smaller than the standard range is present in the plurality of nozzles in the ejection head, the ejection head to perform the main scanning operation by setting the line density of the line formed by any of the plurality of nozzles other than the defective nozzle to be higher than the normal-condition density in at least some of the main scanning operations.

16. A building system configured to build a product which is three-dimensional by additive manufacturing, comprising:
a building apparatus configured to build an object; and
a data generation apparatus configured to generate a data to be supplied to the building apparatus,
the building apparatus comprising:
an ejection head including a plurality of nozzles each configured to eject a building material that is a material used for building;
a scan driver configured to control the ejection head to perform a main scanning operation in which the building material is ejected from the plurality of nozzles while the ejection head moves in a main scanning direction set in advance relatively to the product being built; and
a controller configured to control operations of the ejection head and the scan driver, wherein
the ejection head includes the plurality of nozzles arranged at positions shifted from one another in a sub scanning direction orthogonal to the main scanning direction,
in a case where an arrangement of dots formed by the building material ejected from one of the plurality of nozzles in a single main scanning operation is defined as a line, an amount of the building material included in a unit length in the line is defined as a line density, a nozzle of the plurality of nozzles in which an ejection amount that is the amount of the building material ejected from one of the plurality of nozzles in one of the ejection operations falls within a standard range set in advance is defined as a normal nozzle, and a nozzle of the plurality of nozzles other than the normal nozzle is defined as a defective nozzle,
when all of the plurality of nozzles in the ejection head are the normal nozzles, the controller controls the ejection head to perform the main scanning operation by setting the line density of the line formed by each of the plurality of nozzles to be a normal-condition density set in advance,
when the defective nozzle in which the ejection amount is smaller than the standard range is present in the plurality of nozzles in the ejection head, the controller controls the ejection head to perform the main scanning operation by setting the line density of the line formed by any of the plurality of nozzles other than the defective nozzle to be higher than the normal-condition density in at least some of the main scanning operations,
the data generation apparatus generates an ejection position designation data that is a data for designating a position at which the building material is ejected from each of the plurality of nozzles in the ejection head,
the building apparatus receives the ejection position designation data from the data generation apparatus,
in the main scanning operation, the controller controls each of the plurality of nozzles in the ejection head to eject the building material based on the ejection position designation data,
when the defective nozzle having a small ejection amount is present, the data generation apparatus generates a defective nozzle presence data which is the ejection position designation data for controlling the defective nozzle not to eject the building material and setting the line density of the line formed by any of the plurality of nozzles other than the defective nozzle to be higher than the normal-condition density, and
the controller controls each of the plurality of nozzles to eject the building material based on the defective nozzle presence data to set the line density of the line formed by any of the plurality of nozzles other than the defective nozzle to be higher than the normal-condition density.
